(19) United States
(12) Patent Application Publication
(10) Pub. No.: US 2009/0113092 A1
(43) Pub. Date: Apr. 30, 2009

(54) SIGNAL CONVERTER FOR DEBUGGING THAT EXPANDS FIFO CAPACITY

(75) Inventors: Wen-Liang Hung, Nantou County (TW); Jyun-Da Liao, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: UNIVERSAL SCIENTIFIC INDUSTRIAL CO.,LTD., Tsao Tuen (TW)

(21) Appl. No.: 12/247,593

(22) Filed: Oct. 8, 2008

(30) Foreign Application Priority Data
Oct. 25, 2007 (TW) 96217933

(51) Int. Cl. G06F 13/42

(52) U.S. Cl. 710/71

(57) ABSTRACT

A signal converter includes an interconnect interface, a FIFO set, which comprises a transmitter FIFO and a receiver FIFO respectively connected to the interconnect interface through a data bus, a parallel/serial converter connected to the transmitter FIFO and the receiver FIFO by two data buses respectively and kept apart from the FIFO set, and a serial I/O interface connected to the parallel/serial converter.

### BACKGROUND OF THE INVENTION

1. Field of the Invention

The present invention relates to a signal converter for use in an electronic circuit for debugging and more particularly, to a signal converter that expands FIFO capacity.

2. Description of the Related Art

According to the signal conversion technique of an ordinary debug device, a parallel/serial converter is integrated into a FIFO (First in First out register) of a predetermined capacity, for example, 128 bits, for signal conversion. During signal conversion, the FIFO receives parallel signal from an external device (for example, personal computer) through a data bus and then transmits it to the parallel/serial converter for conversion into serial signal for output.

In the aforesaid FIFO integrated parallel/serial converter, the capacity of the FIFO is limited, not sufficient to receive a big amount of external data during debugging. Therefore, when the FIFO is full load or the amount of data received by the FIFO reaches a predetermined level during debugging, the FIFO integrated parallel/serial converter immediately informs the external device to interrupt the transmission, and the external device can continue the transmission of the data again only after the FIFO has transmitted received data. Because of low capacity of the FIFO, the system must wait during interruption of transmission, lowering the data transmission speed and resulting in a slow debugging process. Small FIFO capacity means multiple interruptions and long waiting time.

Therefore, it is desirable to provide a signal converter that solves the problem of FIFO capacity, accelerating data transmission/conversion speed and improving the debugging performance.

### SUMMARY OF THE INVENTION

The present invention has been accomplished under the circumstances in view. It is one object of the present invention to provide a signal converter for debugging that uses a high capacity FIFO set for receiving data in whole without interruption, saving much waiting time and accelerating the debug process.

To achieve this and other objects of the present invention, the signal converter comprises an interconnect interface, a FIFO set, which comprises a transmitter FIFO and a receiver FIFO respectively connected to the interconnect interface through a data bus, a parallel/serial converter connected to the transmitter FIFO and the receiver FIFO by two data buses respectively and kept apart from the FIFO set, and a serial input/output (I/O) interface connected to the parallel/serial converter.

By means of the aforesaid arrangement, the FIFO set has a high capacity and is kept apart from the parallel/serial converter, and therefore the data can be wholly received without interruption, saving much waiting time and accelerating the debugging process.

### BRIEF DESCRIPTION OF THE DRAWINGS

FIG. 1 is a circuit block diagram of a signal converter according to the present invention.

FIG. 2 is a block diagram showing the signal converter connected between an external device to be debugged and a debug device.

### DETAILED DESCRIPTION OF THE INVENTION

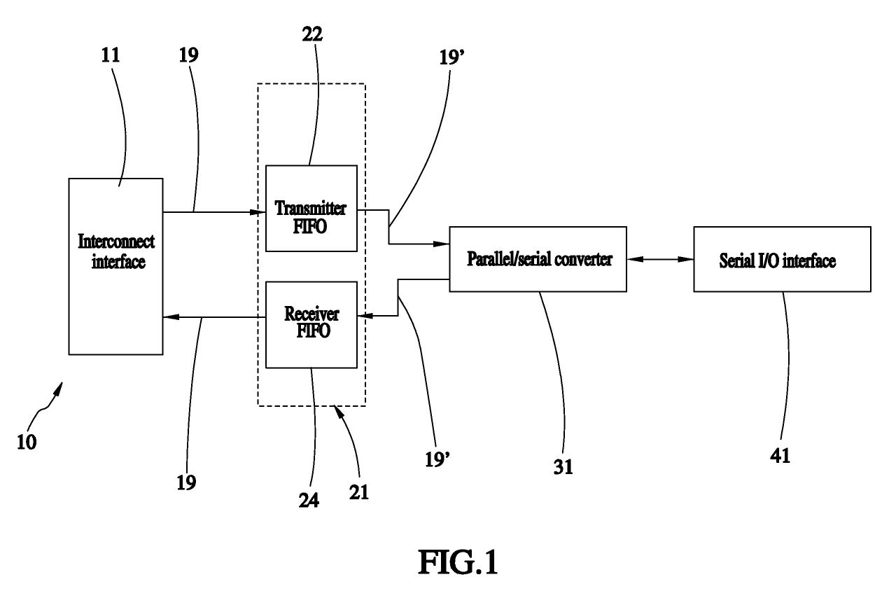

Referring to FIG. 1, a signal converter 10 in accordance with the present invention is shown comprised of an interconnect interface 11, a FIFO set 21, a parallel/serial converter 31, and a serial I/O interface 41.

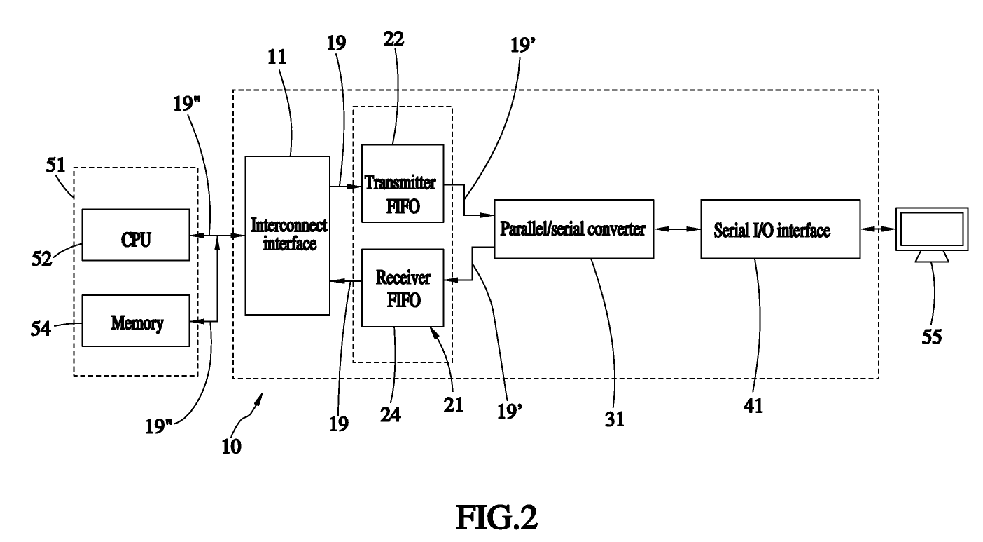

The interconnect interface 11 is for the connection of an external device 51 to be debugged for data transfer (see FIG. 2).

The FIFO set 21 comprises a transmitter FIFO 22 and a receiver FIFO 24. The transmitter FIFO 22 and the receiver FIFO 24 are respectively connected to the interconnect interface 11 through a respective data bus 19. The capacity of the transmitter FIFO 22 and the receiver FIFO 24 is, for example, greater or equal to 1K-bit (1024 bits).

The parallel/serial converter 31 according to the present preferred embodiment is a CPLD (Complex Programmable Logic Device) connected to the transmitter FIFO 22 and the receiver FIFO 24 by two data buses 19′, wherein the FIFO set 21 and the parallel/serial converter 31 are kept apart.

The serial I/O interface 41 according to the present preferred embodiment is a RS-232 interface connected to the parallel/serial converter 31.

During an application of the signal converter 10, as shown in FIG. 2, the CPU 52 and memory 54 of the device 51 to be debugged are respectively connected to the interconnect interface 11 by a data bus 19″, and a debug device 55 is connected to the serial I/O interface 41, enabling the device 51 to be debugged to transfer data through the data bus 19″ to the interconnect interface 11 and then the transmitter FIFO 22.

Because the transmitter FIFO 22 and the receiver FIFO 24 have a high capacity, all the data transmitted from the device 51 to be debugged through the data bus 19″ can be completely received without informing the device 51 to interrupt data transmission. Upon receipt of data, the transmitter FIFO 22 immediately transmits received data to the parallel/serial converter 31 for parallel-to-serial conversion and for further transmission through the serial I/O interface 41 to the debug device 55 after conversion.

The response data from the debug device 55 is transmitted through the serial I/O interface 41 to the parallel/serial converter 31 for serial-to-parallel conversion and the converted parallel data is then transmitted to the receiver FIFO 24 and then transmitted by the receiver FIFO 24 to the device 51 to be debugged through the interconnect interface 11. At this stage, the high capacity of the receiver FIFO 24 allows transmission of the complete data without interruption. Therefore, the invention greatly shortens waiting time.

As stated above, the invention has the FIFO set 21 be separated from the parallel/serial converter 31 so that the high capacity of the FIFO set 21 allows transmission of the whole data at a time without interruption, saving much waiting time and accelerating the debugging process.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A signal converter comprising:
an interconnect interface;
a FIFO set, said FIFO set comprising a transmitter FIFO and a receiver FIFO respectively connected to said interconnect interface through a data bus;
a parallel/serial converter connected to said transmitter FIFO and said receiver FIFO by two data buses respectively and kept apart from said FIFO set; and
a serial I/O interface connected to said parallel/serial converter.

2. The signal converter as claimed in claim 1, wherein said serial I/O interface is a RS-232 interface.

3. The signal converter as claimed in claim 1, wherein said parallel/serial converter is a CPLD (Complex Programmable Logic Device).
